(19) United States
(12) Patent Application Publication
(10) Pub. No.: US 2020/0250766 A1
(43) Pub. Date: Aug. 6, 2020

(54) AUTOMATED CUSTOMER ENROLLMENT USING MOBILE COMMUNICATION DEVICES

(71) Applicant: Teachers Insurance and Annuity Association of America, New York, NY (US)

(72) Inventors: Anand Sancheti, Cherry Hill, NJ (US); Scott M. Blandford, Hopewell, NJ (US); Tasneem Hajara, Hillsborough, NJ (US); Lisa R. Weil, Sudbury, MA (US); Phaneendra Pochinapeddi, Princeton Junction, NJ (US); Raja Doddala, Flower Mound, TX (US); Peter Tsahalis, Colst Neck, NJ (US); Christopher Petta, New Brunswick, NJ (US)

(21) Appl. No.: 16/268,758

(22) Filed: Feb. 6, 2019

(51) Int. Cl. G06Q 40/00; G06Q 30/00; G06Q 10/02; G06K 9/00

(52) U.S. Cl. CPC G06Q 40/12; G06Q 30/01; G06F 3/0484; G06K 9/00469; G06Q 10/02

(57) ABSTRACT

Disclosed are methods and systems for automated customer enrollment using mobile communication devices. An example method includes: receiving, by a computer system, an identification document image produced by a mobile communication device; extracting, from the identification document image a personal identifying information item; computing a confidence score of the personal identifying information item; responsive to determining that the confidence score meets or exceeds a confidence threshold, creating a customer profile for a person identified by the identification document, wherein the customer profile comprises the personal identifying information item; and supplying the customer profile to a financial account creation workflow.

### TECHNICAL FIELD

The present disclosure is generally related to distributed computer systems, and is more specifically related to methods and systems of automated customer enrollment using mobile communication devices.

### BACKGROUND

Financial accounts may be held by financial institutions on behalf of respective account holders. Examples of financial institutions include, but are not limited to, banks, building societies, credit unions, trust companies, mortgage loan companies, insurance companies, investment banks, underwriters, brokerage firms, etc. Examples of financial accounts include, but are not limited to, checking accounts, savings accounts, loan accounts, revolving credit accounts, investment accounts, brokerage accounts, retirement accounts, annuity accounts, etc.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 schematically illustrates an example account creation workflow implemented in accordance with one or more aspects of the present disclosure;

FIG. 2 schematically illustrates validation rules for validating personal identifying information items, in accordance with one or more aspects of the present disclosure;

FIG. 3 schematically illustrates a high-level network diagram of an example distributed computer system that may implement the methods described herein;

FIG. 4 depicts a flow diagram of an example method of automated customer enrollment using mobile communication devices, in accordance with one or more aspects of the present disclosure; and

FIG. 5 illustrates a diagrammatic representation of a computer system that may be employed for implementing the methods described herein.

### DETAILED DESCRIPTION

Described herein are methods and systems of automated customer enrollment using mobile communication devices.

A financial institution may provide various online applications (e.g., a web-based application or a downloadable smartphone application) that may be employed by existing and potential customers for performing various financial account management operations and/or financial transactions. In particular, a financial institution may provide an online application for new customer enrollment. In an illustrative example, a customer enrollment application may be implemented by a series of SMS requests and responses, a web-based application or a downloadable smartphone application, which a potential customer may activate by scanning an indicia bearing image (such as a QR code) using mobile communication devices (such as smartphones, tablets, etc.) or by responding to an SMS message prompt sent to the potential customer's mobile communication device by the financial institution.

Once activated, the customer enrollment application may prompt the potential customer to acquire an image of the potential customer's identification document (e.g., using the camera of the mobile communication device). The identification document may be, for example, a driver's license, a non-driver identification document, a passport, a student identification document, an employer-issued identification document, a library card, etc. The customer enrollment application may then determine the document type and extract one or more personal identifying information items from the identification document image. In an illustrative example, the information extraction may involve performing optical character recognition (OCR) of the identification document image in order to extract one or more textual strings, which specify the person's name, date of birth, residential address, and/or various other personal identifying information items. In another illustrative example, a personal identification document (e.g., a driver's license) may bear one or more images of two-dimensional barcodes (such as PDF417 barcodes); accordingly, the information extraction may involve detecting and decoding one or more barcode symbols contained by the identification document image in order to extract one or more textual strings specifying the person's name, date of birth, residential address, and/or various other personal identifying information items.

The extracted information may be fed to the enrollment information validation workflow, which may utilize artificial intelligence methods (such as machine learning-based classifiers, rule engines, etc.) to validate the extracted personal identifying information using various available information sources, as described in more detail herein below. The validation result may be reflected by a confidence score assigned to the extracted personal identifying information. Should the score exceed a predetermined or dynamically configurable confidence threshold, the customer enrollment application may generate a customer profile based on the extracted personal identifying information and other information that may be obtained from various information sources (such as public records and/or private or public databases). The generated customer profile may be visualized via the graphical user interface (GUI) of the mobile communication device and, upon receiving the user's confirmation, may be fed to an account creation workflow.

Conversely, should the score fall below the confidence threshold, the customer enrollment application may generate an incomplete customer profile based on the extracted personal identifying information and other information that may be obtained from various information sources (such as public records and/or private or public databases). The generated incomplete customer profile may be visualized via the GUI of the mobile communication device and, upon receiving the user's confirmation, may be fed to a customer information collection workflow for collecting the missing customer information. The customer information collection workflow may produce the complete customer profile, which may then be fed to the account creation workflow.

The account creation workflow may, upon successfully performing necessary verification operations (e.g., based on know your customer (KYC) requirements), create a new financial account and notify the customer (e.g., via the online application, electronic mail message, automated voice notification over a telephone network, etc.).

Thus, the systems and methods of the present disclosure improve the customer satisfaction and improve the operating efficiency by eliminating the costs that were previously associated with manually performing the automated operations, as described in more detail herein below. Various aspects of the methods and systems are described herein by way of examples, rather than by way of limitation. The methods described herein may be implemented by hardware (e.g., general purpose and/or specialized processing devices, and/or other devices and associated circuitry), software (e.g., instructions executable by a processing device), or a combination thereof.

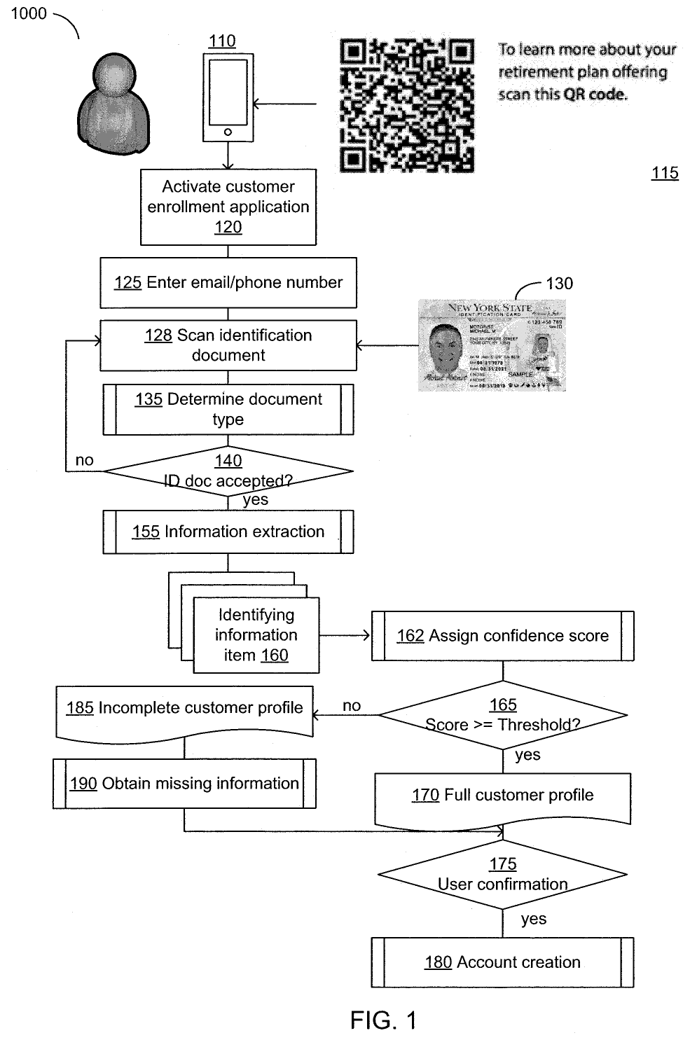

FIG. 1 schematically illustrates an example account creation workflow implemented in accordance with one or more aspects of the present disclosure. As schematically illustrated by FIG. 1, the account creation workflow 1000 may be triggered by a potential customer employing a mobile communication device 110 (such as a smartphone, a tablet, etc.) for scanning an indicia bearing image 115 (e.g., found on the financial institution's website, in a printed publication, or affixed to a structure or object that may be located at the potential customer's workplace, in a public space, or at a venue of a customer enrollment event organized by the financial institution). Processing the indicia bearing image by the mobile communication device may cause the device to download and install a standalone customer enrollment application 120 or access a web-based customer enrollment application 120 employed for customer enrollment by a certain financial institution. Alternatively, the customer enrollment application 120 may be triggered by a link included in a message (e.g., SMS message) received by the customer's mobile communication device. Alternatively, the customer enrollment application 120 may be implemented by a series of SMS requests and responses, which is triggered by the potential customer's responding to an SMS message prompt sent to the potential customer's mobile communication device by the financial institution.

Once activated, the customer enrollment application 120 may prompt the potential customer to enter his or her electronic mail address and/or phone number (operation 125). The customer enrollment application may then prompt (operation 128) the potential customer to acquire an image of his or her identification document 130 (e.g., a driver's license, a non-driver identification document, a passport, a student identification document, an employer-issued identification document, a library card, etc.). The customer enrollment application may then determine (operation 135) the document type and, based on the determined document type, may accept or reject (operation 140) the identification document 130. In various illustrative examples, the document acceptance decision may be made by one or more machine learning-based classifiers and/or rule engines implementing a set of predetermined or dynamically configured rules. In certain implementations, the customer enrollment application may be configured to only accept certain document types (e.g., government-issued photo identification documents, identification documents issued by certain entities, identification documents that are compliant with certain identification document security standards, identification documents that have certain security features, etc.), while rejecting other document types. If the identification document is rejected, the user may be prompted (operation 128) to acquire an image of another identification document.

If the identification document is accepted, the customer enrollment application may extract (operation 155) one or more personal identifying information items 160 from the identification document image. In an illustrative example, the information extraction may involve performing optical character recognition (OCR) of the identification document image in order to extract one or more textual strings, which may then be parsed to determine the person's name, date of birth, residential address, and/or various other personal identifying information items. In another illustrative example, a personal identification document (e.g., a driver's license) may bear one or more images of two-dimensional barcodes (such as PDF417 barcodes); accordingly, the information extraction may involve detecting and decoding one or more barcode symbols contained by the identification document image in order to extract one or more textual strings, which may then be parsed to determine the person's name, date of birth, residential address, and/or various other personal identifying information items.

The customer enrollment application may then validate and assign a confidence score (operation 162) to the extracted personal identifying information. In various illustrative examples, the validation and confidence score assignment operation 162 may be performed by one or more machine learning-based classifiers and/or rule engines implementing a set of predetermined or dynamically configured rules.

The confidence score may be initialized by setting the score to a predetermined value (e.g., zero). Each validation operation may adjust the confidence score (e.g., by adding a predetermined or dynamically configurable increment value to the current value of the confidence score).

In particular, one or more items of the extracted personal identifying information may be validated against one or more proprietary or public information sources (such as publicly available or private databases). Successful validation (i.e., the full match of the personal identifying information extracted from the identification document and the information obtained from the external information source) may result in incrementing the confidence score by a predetermined or dynamically configurable value reflecting the relative importance of the validated personal identifying information items to the resulting customer profile. Partial match of the personal identifying information extracted from the identification document and the information obtained from the external information source may result in incrementing the confidence score by a reduced, as compared to the full match scenario, increment value. Failure to validate (i.e., a clear mismatch of the personal identifying information extracted from the identification document and the information obtained from the external information source) may result in decrementing the confidence score by a predetermined or dynamically configurable value reflecting the relative importance of the validated personal identifying information items to the resulting customer profile or resetting the confidence score to a predetermined value (e.g., zero).

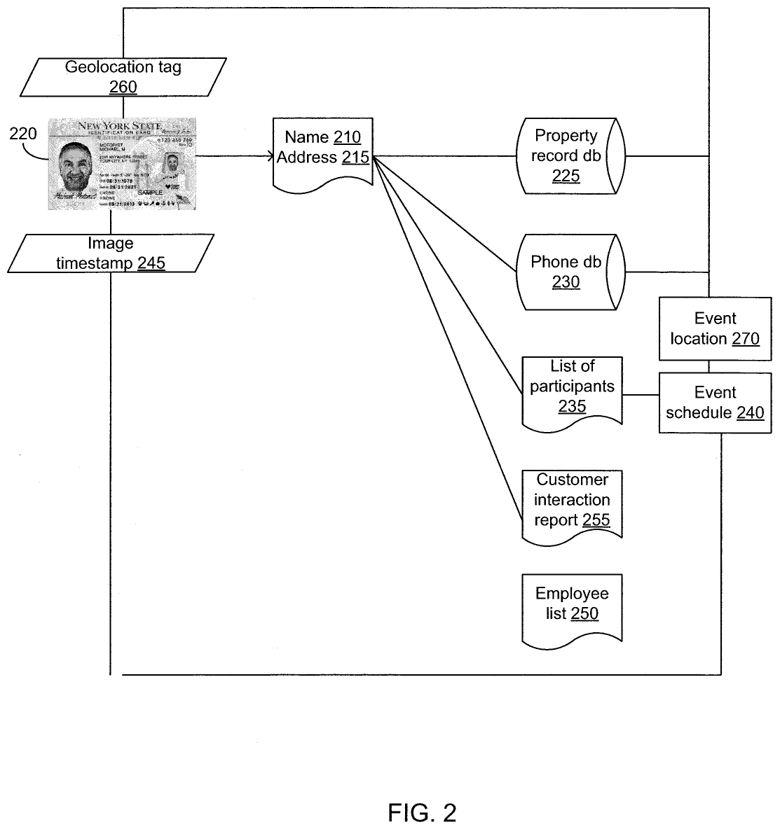

As schematically illustrated by FIG. 2, the person's name 210 and residential address 215 extracted from the identification document image 220 produced by the customer's mobile communication device may be validated against the property record database 225 maintained by the municipality in which the address is located. In certain implementations, the extracted name 210 and residential address 215 may be validated against a phone database 230 published by a telecommunication service provider. The validation result may be reflected by adjusting the confidence score assigned to the name and address. For example, if the person's name and address extracted from the identification document image 220 match the name and address retrieved from the external information source, the confidence score may be incremented by a predetermined or dynamically configurable value; otherwise, the confidence value may be decremented by a predetermined or dynamically configurable value or may be reset to a predetermined value.

In certain implementations, the person's name 210 and residential address 215 extracted from the identification document image 220 may be validated against a list 235 of participants of a customer enrollment event that has been conducted by the financial institution, for example, at a workplace of potential customers or in a public space. In an illustrative example, a customer enrollment event may be organized for employees of an organization that offers its employees certain financial products (e.g., retirement plans) provided by the financial institution that utilizes the customer enrollment application 120 of FIG. 1). In another illustrative example, a public promotional event may be organized for a certain financial instrument, such as a co-branded credit card or a high-yield savings account. The validation result may be reflected by adjusting the confidence score assigned to the name and address. For example, if the person's name matches a name retrieved from the list of participants of a customer enrollment event, the confidence score may be incremented by a predetermined or dynamically configurable value; otherwise, the confidence value may be decremented by a predetermined or dynamically configurable value or may be reset to a predetermined value.

In certain implementations, the schedule 240 (e.g., the event start time and/or the event end time) of the customer enrollment event may be compared to the timestamp 245 associated with the identification document image 220, and the confidence score may be further adjusted to reflect the comparison result. For example, if the image timestamp falls within the event timeframe, the confidence score may be incremented by a predetermined or dynamically configurable value; otherwise, the confidence value may be decremented by a predetermined or dynamically configurable value or may be reset to a predetermined value.

In certain implementations, the geolocation information 260 associated with the identification document image 220 may be compared to the location 270 of the customer enrollment event. The validation result may be reflected by adjusting the confidence score assigned to the extracted personal identifying information items. For example, if the geolocation information 260 associated with the identification document image 220 matches the geolocation of the venue of the customer enrollment event, the confidence score may be incremented by a predetermined or dynamically configurable value; otherwise, the confidence value may be decremented by a predetermined or dynamically configurable value or may be reset to a predetermined value.

In certain implementations, the person's name 210 and residential address 215 extracted from the identification document image 220 may be validated against a list 250 of employees of an organization (such as a corporation, a non-for-profit organization, or a government organization) that offers its employees certain financial products (e.g., retirement plans) provided by the financial institution that utilizes the customer enrollment application 120 of FIG. 1. The validation result may be reflected by adjusting the confidence score assigned to the name and address. For example, if the person's name matches a name retrieved from the list of organization employees, the confidence score may be incremented by a predetermined or dynamically configurable value; otherwise, the confidence value may be decremented by a predetermined or dynamically configurable value or may be reset to a predetermined value.

In certain implementations, the person's name 210 and residential address 215 extracted from the identification document image 220 may be validated against a customer interaction report 255 submitted by an employee or agent of the financial institution to reflect interactions with potential customers, for example, at their workplace or in a public space. The validation result may be reflected by adjusting the confidence score assigned to the name and address. For example, if the person's name matches a name retrieved from the customer interaction report 255, the confidence score may be incremented by a predetermined or dynamically configurable value; otherwise, the confidence value may be decremented by a predetermined or dynamically configurable value or may be reset to a predetermined value.

In certain implementations, the person's name 210 and residential address 215 extracted from the identification document image 220 and/or retrieved from an external information source (such as a municipal property records database) may be validated against the geolocation information 260 associated with the identification document image 220. The validation result may be reflected by adjusting the confidence score assigned to the name and address. For example, if the geolocation information 260 associated with the identification document image 220 matches the residential address 215 extracted from the identification document image 220 and/or retrieved from an external information source, the confidence score may be incremented by a predetermined or dynamically configurable value; otherwise, the confidence value may be decremented by a predetermined or dynamically configurable value or may be reset to a predetermined value.

In certain implementations, the residential address retrieved from an external information source (such as a phone database published by a telecommunication service provider) as the address associated with the phone number supplied by the customer via the customer enrollment application may be compared to the geolocation information 260 associated with the identification document image 220. The validation result may be reflected by adjusting the confidence score assigned to the name and address. For example, if the geolocation information 260 associated with the identification document image 220 matches the residential address retrieved from the external information source, the confidence score may be incremented by a predetermined or dynamically configurable value; otherwise, the confidence value may be decremented by a predetermined or dynamically configurable value or may be reset to a predetermined value.

While the above-described examples reference names and residential addresses, other personal identifying information items (such as the date of birth, employer-assigned identification numbers, government-assigned identification numbers, etc.) may be similarly validated by comparing various combinations of personal identifying information items extracted from the image of the identification document and/or directly supplied by or on behalf of the potential customer (e.g., via the enrollment application) to combinations of personal identifying information items retrieved from proprietary and/or publicly available information sources and adjusting the confidence score based on the outcome of such comparison operations.

Referring again to FIG. 1, the customer enrollment application may compare (operation 165) the resulting confidence score associated with the extracted personal identifying information items to a predetermined or dynamically configurable score threshold. Should the confidence score meet or exceed a predetermined or dynamically configurable confidence threshold, the customer enrollment application may generate a customer profile 170 based on the extracted personal identifying information and other information that may be obtained from various information sources (such as public records and/or private or public databases). The generated customer profile may be visualized (operation 175) via the graphical user interface (GUI) of the mobile communication device and, upon receiving the user's confirmation, may be fed to an account creation workflow 180.

Conversely, should the score fall below the confidence threshold, the customer enrollment application may generate an incomplete customer profile 185 based on the extracted personal identifying information and other information that may be obtained from various information sources (such as public records and/or private or public databases). The generated incomplete customer profile may be fed to a customer information collection workflow 190 for collecting the missing customer information. The customer information collection workflow 190 may produce the complete customer profile, which may then be fed to the account creation workflow 180.

The account creation workflow 180 may, upon successfully performing necessary verification operations (e.g., based on know your customer (KYC) requirements), create a new financial account and notify the customer (e.g., via the online application, electronic mail message, automated voice notification over a telephone network, etc.).

In certain implementations, artificial intelligence methods (such as machine learning-based classifiers, rule engines, etc.) may be employed to dynamically adjust the confidence threshold based on the data obtained by the account creation application by processing a batch of newly-created customer accounts. In an illustrative example, the confidence threshold may be increased by a predetermined value responsive to determining that the account creation workflow 180 has failed to validate at least a certain number (representing a validation failure threshold) of newly-created customer accounts. Conversely, the confidence threshold may be decreased by a predetermined value responsive to determining that the account creation workflow 180 has successfully validated at least a certain number (representing a validation success threshold) of newly-created customer accounts.

In certain implementations, artificial intelligence methods (such as machine learning-based classifiers, rule engines, etc.) may be further employed to dynamically adjust the score increment values utilized by the above-described personal identifying information item validation procedures. In an illustrative example, a score increment value utilized by a validation procedure may be increased by a predetermined value responsive to determining that the account creation workflow 180 has successfully validated at least a certain number (representing a validation success threshold) of personal identifying information items yielded by that validation procedure. In another illustrative example, a score increment value utilized by a validation procedure may be decreased by a predetermined value responsive to determining that the account creation workflow 180 has failed to successfully validate at least a certain number (representing a validation failure threshold) of personal identifying information items yielded by that validation procedure.

It should be noted that various functions described herein as being performed by the customer enrollment application may be performed by the application installed and running on the customer's mobile communication device and/or by one or more server-side applications (such as web servers, application servers, and/or database servers) to which the customer's mobile communication device may communicate over one or more networks. For example, the client application running on the customer's mobile communication device may upload the acquired image of the identification document to a server for further processing (information extraction and validation). Alternatively, some image processing operations may be performed locally on the customer's mobile communication device, while the information extraction and validation operations may be performed by one or more servers, which may be located in a private or public cloud or in a private network (such as a corporate network of the financial institution).

While the customer enrollment application in the above-described example is a web-based application, the same or similar functionality may be delivered to the user by various other means.

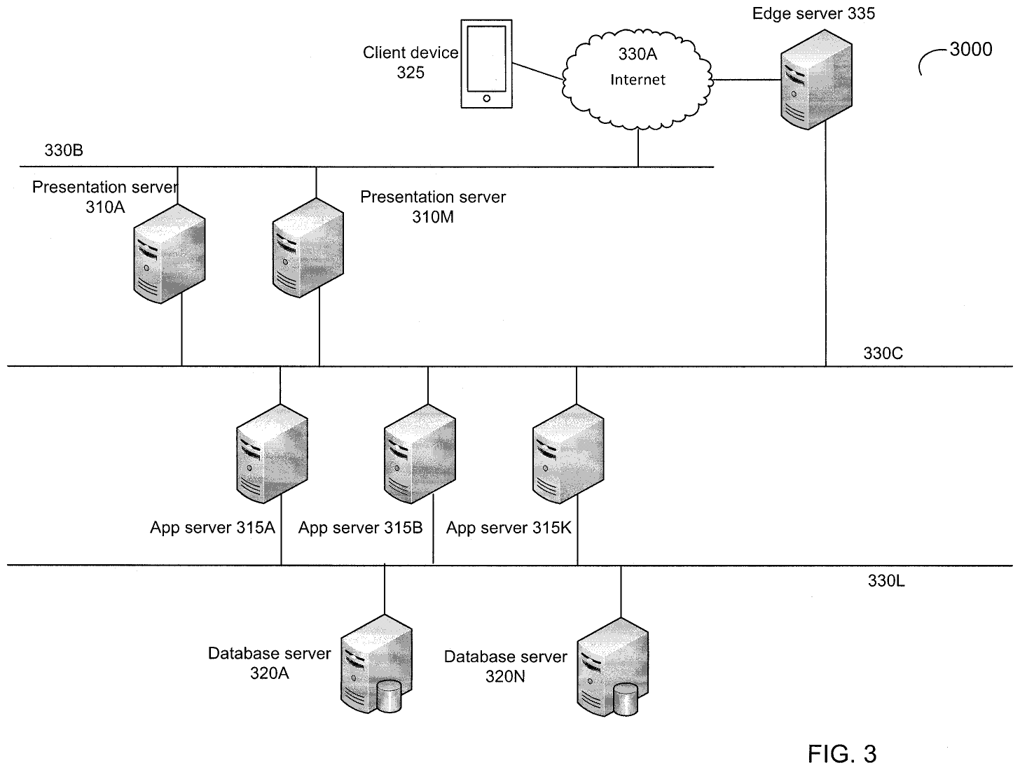

FIG. 3 schematically illustrates a high-level network diagram of an example distributed computer system 3000, which may implement the methods described herein. Servers, appliances, and network segments are shown in FIG. 3 for illustrative purposes only and do not in any way limit the scope of the present disclosure. Various other servers, components, appliances, and/or methods of their interconnection may be compatible with the methods and systems described herein. Firewalls, load balancers, network switches and various other networking components may be omitted from FIG. 3 for clarity and conciseness.

The example distributed computer system 3000 may include one or more presentation servers 310A-310M, application servers 315A-315K, database servers 320A-320N, and/or various other servers. The example distributed computer system 3000 may be configured to service requests initiated by a plurality of geographically distributed client devices 325.

Requests initiated by a client device 325 (e.g., a smartphone, a tablet, or some other mobile communication device) may be routed, over one or more networks 330A-330L, to an edge server 335, which may then select, e.g., based on a load balancing scheme, a presentation server 310 to which the client request should be forwarded. In addition to performing the load balancing, edge servers 335 may serve static content in response to client HTTP requests and/or perform various other tasks.

In an illustrative example, a plurality of edge servers 335 may be geographically distributed so that a request initiated by the client device 325 would be routed to an edge server 335, which is selected based on the client geographic location and/or other request parameters. The edge server 335 may then forward the client-initiated request to a presentation server 310, which may be selected, e.g., by implementing a round robin scheme or a load balancing mechanism. The presentation server 310 may, upon parsing the request, issue one or more requests to one or more application servers 315A-315K configured to implement various functions of one or more online applications (e.g., document image recognition, information extraction and validation, etc.). An application server 315 may process a request received from a presentation server 310 and produce a response to be returned to the client device 325. The request processing by the application server 315 may comprise issuing one or more requests to one or more database servers 320A-320N. The presentation server 310 may then wrap the response produced by the application server 315 into one or more HTTP response messages and return the response messages to the client device 325 (e.g., via an edge server 330).

The above-described architecture of the example distributed computer system 3000 serves as an illustrative example only and does not in any way limit the scope of the present disclosure. References herein to presentation servers, application servers, database servers, and/or other components of example distributed computer systems are purely functional, as a single hardware system or a single software component may implement functions of one or more functional components that are described or referenced herein. Various other system architectures may be compatible with the methods and systems implemented in accordance with one or more aspects of the present disclosure.

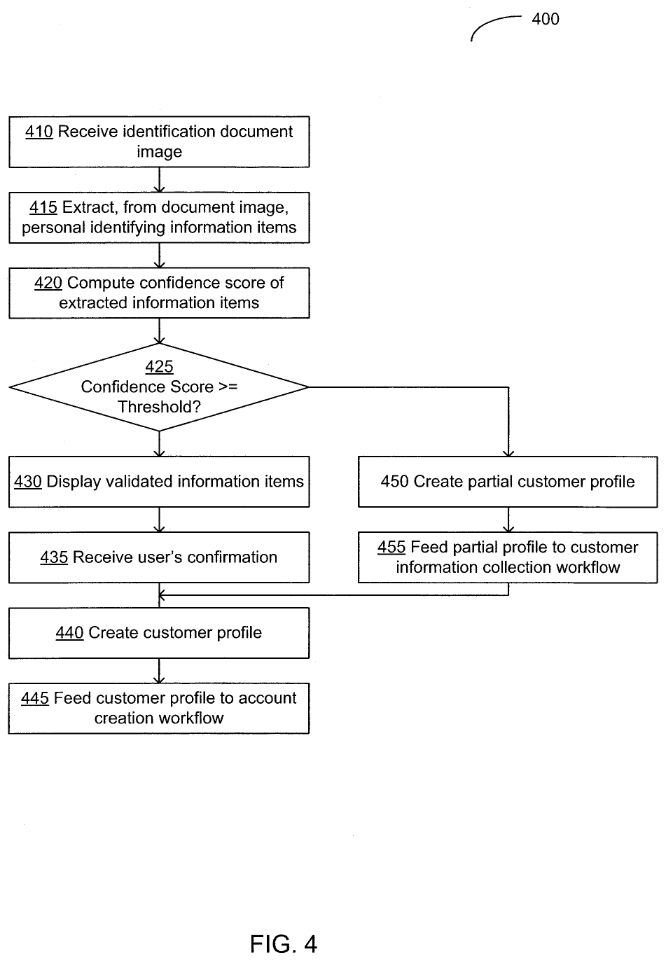

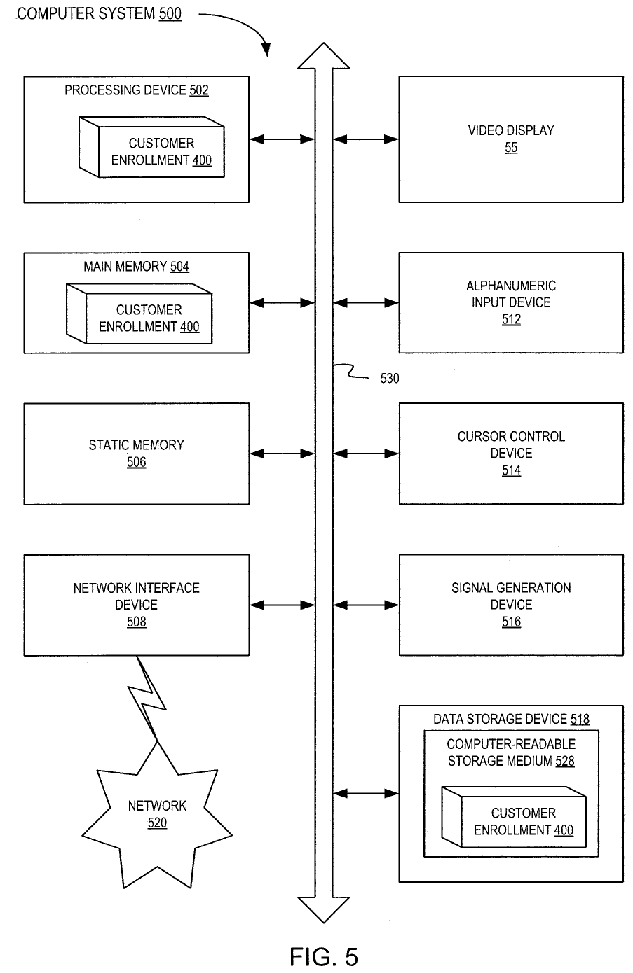

FIG. 4 depicts a flow diagram of an example method 400 of automated customer enrollment using mobile communication devices, in accordance with one or more aspects of the present disclosure. Method 400 and/or each of its individual functions, routines, subroutines, or operations may be performed by one or more general purpose and/or specialized processing devices. Two or more functions, routines, subroutines, or operations of method 400 may be performed in parallel or in an order that may differ from the order described above. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other. In an illustrative example, method 400 may be performed by the computer system 500 of FIG. 5.

Referring to FIG. 4, at block 410, the computer system implementing the method may receive an image of an identification document acquired by the customer's mobile communication device, as described in more detail herein above.

At block 415, the computer system may extract from the image one or more personal identifying information items. In an illustrative example, the information extraction may involve performing optical character recognition (OCR) of the identification document image in order to extract one or more textual strings that specify the person's name, date of birth, residential address, and/or various other personal identifying information items. In another illustrative example, a personal identification document (e.g., a driver's license) may bear one or more images of two-dimensional barcodes (such as PDF417 barcodes); accordingly, the information extraction may involve detecting and decoding one or more barcode symbols contained by the identification document image in order to extract one or more textual strings specifying the person's name, date of birth, residential address, and/or various other personal identifying information items.

At block 420, the computer system may compute a confidence score of one or more extracted personal identifying information items. In various illustrative examples, the confidence score computation may be performed by one or more machine learning-based classifiers and/or rule engines implementing a set of predetermined or dynamically configured rules. The confidence score may be initialized by setting the score to a predetermined value (e.g., zero). Each validation operation may adjust the confidence score (e.g., by adding a predetermined or dynamically configurable increment value to the current value of the confidence score), as described in more detail herein above.

Successful validation (i.e., the full match of the personal identifying information extracted from the identification document and the information obtained from the external information source) may result in incrementing the confidence score by a predetermined or dynamically configurable value reflecting the relative importance of the validated personal identifying information items to the resulting customer profile. Partial match of the personal identifying information extracted from the identification document and the information obtained from the external information source may result in incrementing the confidence score by a reduced, as compared to the full match scenario, increment value. Failure to validate (i.e., a clear mismatch of the personal identifying information extracted from the identification document and the information obtained from the external information source) may result in decrementing the confidence score by a predetermined or dynamically configurable value reflecting the relative importance of the validated personal identifying information items to the resulting customer profile or resetting the confidence score to a predetermined value (e.g., zero).

In certain implementations, the confidence score may be adjusted by a value indicative of outcome of validation of the personal identifying information items against a public or proprietary information source. In an illustrative example, if a person's name extracted from the image of the identification document matches a name retrieved from the public or proprietary information source, a relatively high confidence score may be assigned to the hypothesis of the identification document holder being a valid potential customer of the financial institution.

In certain implementations, the confidence score may be adjusted by a value indicative of outcome of validation of the personal identifying information item against a list of participants of a specified event (such as a customer enrollment event). In an illustrative example, if a person's name extracted from the image of the identification document matches a name retrieved from the list of participants of a customer enrollment event, a relatively high confidence score may be assigned to the hypothesis of the identification document holder being a valid potential customer of the financial institution.

In certain implementations, the confidence score may be adjusted by a value indicative of outcome of validation of the personal identifying information item against a customer interaction report. In an illustrative example, if a person's name extracted from the image of the identification document matches a name retrieved from the customer interaction report, a relatively high confidence score may be assigned to the hypothesis of the identification document holder being a valid potential customer of the financial institution.

In certain implementations, validation procedures implemented by the computer system may include sequences of two or more validation operations. In an illustrative example, the computer system may determine, using one or more public or proprietary information sources (such as property record databases, telephone databases, etc.), a residence address associated with the identification document holder. The confidence score may be adjusted by a value indicative of outcome of comparing the geolocation tag associated with the image of the identification document and the geolocation of the residence address and the identification document holder being a valid potential customer of the financial institution.

In another illustrative example, the computer system may determine, using one or more public or proprietary information sources (such as property record databases, telephone databases, etc.), a residence address associated with the communication service subscriber identifier (such as a phone number) associated with the customer's mobile communication device. The confidence score may be adjusted by a value indicative of outcome of comparing the geolocation tag associated with the image of the identification document and the geolocation of the residence address. Thus, if the geolocation tag associated with the image of the identification document matches the geolocation of the residence address, a relatively high confidence score may be assigned to the hypothesis of the document image having been acquired at the customer's residence and the identification document holder being a valid potential customer of the financial institution.

In certain implementations, the confidence score may be adjusted by a value indicative of a combination of two or more scoring factors (e.g., a weighted sum of the scoring factors), such that each of the scoring factors may reflect a certain aspect of the validity of the extracted personal identifying information. In an illustrative example, the first scoring factor may be computed by comparing the geolocation tag associated with the acquired image of the identification document and the geolocation of the venue of a specified event (such as a customer enrollment event), while the second scoring factor may be computed by comparing the timestamp of the acquired image of the identification document and the schedule of the specified event. Accordingly, the confidence score may be adjusted by a value indicative of the combination of the first and second scoring factors (e.g., may be incremented by the weighted sum of the first and second scoring factors). Thus, if the geolocation tag associated with the image of the identification document matches the geolocation of the venue of a customer enrollment event, and the timestamp of the image matches the schedule of the event, a relatively high confidence score may be assigned to the hypothesis of the document image having been acquired at the customer enrollment event and the identification document holder being a valid potential customer of the financial institution.

Responsive to determining, at block 425, that the confidence score meets or exceeds a predetermined or dynamically configurable confidence threshold, the computer system may, at block 430, visually represent one or more validated personal identifying information items via a graphical user interface (GUI) and prompt the user to confirm the correctness of the displayed information; otherwise, the method may branch to block 450.

At block 435, the computer system may receive, via the GUI, a user input confirming validity of the personal identifying information item and consenting to creation of one or more financial accounts. In certain implementations, the user may further select one or more account types and provide additional information with respect to the account(s) being created.

At block 440, the computer system may create a customer profile for the identification document holder, based on the validated personal identifying information items and other information provided by the customer.

At block 445, the computer system may feed the created customer profile to a financial account creation workflow, which may optionally perform further validation operations (e.g., in order to provide compliance with applicable laws and regulations, such as know your customer (KYC) regulations) and then create, using the customer profile, one or more financial accounts for the identification document holder. Upon completing the operations of block 445, the method may terminate.

At block 450, to which the method may branch from block 425, the computer system may create a partial customer profile for the identification document holder, based on the validated personal identifying information items and other information provided by the customer.

At block 455, the computer system may feed the created partial customer profile to a customer information collection workflow for collecting and validating one or more items of the missing customer information. The customer information collection workflow may produce the complete customer profile, which may then be fed to the account creation workflow, which may optionally perform further validation operations (e.g., in order to provide compliance with applicable laws and regulations, such as know your customer (KYC) regulations) and then create, using the customer profile, one or more financial accounts for the identification document holder.

FIG. 5 illustrates a diagrammatic representation of a computer system 500, which may be employed for implementing the methods described herein. The computer system 500 may be connected to other computing devices in a LAN, an intranet, an extranet, and/or the Internet. The computer system 500 may operate in the capacity of a server machine in a client-server network environment. The computer system 500 may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computer system” shall also be taken to include any collection of computing devices that individually or jointly execute a set (or multiple sets) of instructions to perform the methods discussed herein. In illustrative examples, the computer system 500 may represent one or more servers implementing the above-described method 400 of automated customer enrollment using mobile communication devices.

The example computer system 500 may include a processing device 502, a main memory 504 (e.g., synchronous dynamic random access memory (DRAM), read-only memory (ROM)), and a static memory 506 (e.g., flash memory and a data storage device 518), which may communicate with each other via a bus 530.

The processing device 502 may be provided by one or more general-purpose processing devices such as a microprocessor, central processing unit, or the like. In an illustrative example, the processing device 502 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also comprise one or more special-purpose processing devices such as an application specific integrated circuit (ASIC), a field programmable gate array (FPGA), a digital signal processor (DSP), a network processor, or the like. The processing device 502 may be configured to execute the method 400 of automated customer enrollment using mobile communication devices, in accordance with one or more aspects of the present disclosure.

The computer system 500 may further include a network interface device 508, which may communicate with a network 520. The computer system 500 also may include a video display unit 55 (e.g., a liquid crystal display (LCD) or a cathode ray tube (CRT)), an alphanumeric input device 512 (e.g., a keyboard), a cursor control device 514 (e.g., a mouse) and/or an acoustic signal generation device 516 (e.g., a speaker). In one embodiment, video display unit 55, alphanumeric input device 512, and cursor control device 515 may be combined into a single component or device (e.g., an LCD touch screen).

The data storage device 518 may include a computer-readable storage medium 528 on which may be stored one or more sets of instructions (e.g., instructions of the method 400 of automated customer enrollment using mobile communication devices, in accordance with one or more aspects of the present disclosure) implementing any one or more of the methods or functions described herein. Instructions implementing the method and system 400 may also reside, completely or at least partially, within main memory 504 and/or within processing device 502 during execution thereof by computer system 500, main memory 504 and processing device 502 also constituting computer-readable media. The instructions may further be transmitted or received over a network 520 via network interface device 508.

While computer-readable storage medium 528 is shown in an illustrative example to be a single medium, the term “computer-readable storage medium” shall be taken to include a single medium or multiple media (e.g., a centralized or distributed database and/or associated caches and servers) that store one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “identifying,” “determining,” or the like refer to actions and processes performed or implemented by computing devices that manipulate and transform data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc. as used herein are meant as labels to distinguish among different elements and may not necessarily have an ordinal meaning according to their numerical designation.

Examples described herein also relate to an apparatus for performing the methods and systems described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

What is claimed is:

1. A method, comprising:
receiving, by a computer system, an identification document image produced by a mobile communication device;
extracting, from the identification document image, a personal identifying information item;
computing a confidence score of the personal identifying information item;
responsive to determining that the confidence score meets or exceeds a confidence threshold, creating a customer profile for a person identified by an identification document represented by the identification document image, wherein the customer profile comprises the personal identifying information item; and
supplying the customer profile to a financial account creation workflow.

2. The method of claim 1, further comprising:
creating, using the customer profile, a financial account for the person identified by the identification document.

3. The method of claim 1, wherein creating the customer profile further comprises:
visually representing the personal identifying information item via a graphical user interface (GUI); and
receiving, via the GUI, a user input confirming validity of the personal identifying information item.

4. The method of claim 1, wherein computing the confidence score of the personal identifying information item further comprises:
adjusting the confidence score by a value indicative of outcome of validation of the personal identifying information item against an external information source.

5. The method of claim 1, wherein computing the confidence score of the personal identifying information item further comprises:
adjusting the confidence score by a value indicative of outcome of validation of the personal identifying information item against a list of participants of a specified event.

6. The method of claim 1, wherein computing the confidence score of the personal identifying information item further comprises:
adjusting the confidence score by a value indicative of outcome of validation of the personal identifying information item against a customer interaction report.

7. The method of claim 1, wherein computing the confidence score of the personal identifying information item further comprises:
computing a first scoring factor by comparing a geolocation tag associated with the identification document image and a geolocation of a venue of a specified event;
computing a second scoring factor by comparing a timestamp of the identification document image and a schedule of the specified event; and
adjusting the confidence score by a value indicative of a combination of the first scoring factor and the second scoring factor.

8. The method of claim 1, wherein computing the confidence score of the personal identifying information item further comprises:
determining, using an external information source, a residence address associated with the person identified by the identification document; and
adjusting the confidence score by a value indicative of outcome of comparing a geolocation tag associated with the identification document image and a geolocation of the residence address.

9. The method of claim 1, wherein computing the confidence score of the personal identifying information item further comprises:
determining, using an external information source, a residence address associated with a communication service subscriber identifier associated with a communication device that produced the identification document image; and
adjusting the confidence score by a value indicative of outcome of comparing geolocation tag associated with the identification document image and the geolocation of the residence address.

10. The method of claim 1, further comprising:
adjusting the confidence threshold based on validating account creation data of a plurality of financial accounts.

11. The method of claim 1, further comprising:
responsive to determining that the confidence score fails to meet the confidence threshold, creating a partial customer profile for a person identified by the identification document, wherein the partial customer profile comprises the personal identifying information item; and
supplying the partial customer profile to a to a customer information collection workflow.

12. A system, comprising:
a memory; and
a processing device operatively coupled to the memory, wherein the processing device is configured to:
receive an identification document image;
extract, from the identification document image, a personal identifying information item;
compute a confidence score of the personal identifying information item;
responsive to determining that the confidence score meets or exceeds a confidence threshold, create a customer profile for a person identified by an identification document represented by the identification document image, wherein the customer profile comprises the personal identifying information item; and
create, using the customer profile, a financial account for the person identified by the identification document.

13. The system of claim 12, wherein creating the customer profile further comprises:
visually representing the personal identifying information item via a graphical user interface (GUI); and
receiving, via the GUI, a user input confirming validity of the personal identifying information item.

14. The system of claim 12, wherein computing the confidence score of the personal identifying information item further comprises:
adjusting the confidence score by a value indicative of outcome of validation of the personal identifying information item against an external information source.

15. The system of claim 12, wherein the processing device is further configured to:
adjust the confidence threshold based on validating account creation data of a plurality of financial accounts.

16. The system of claim 12, wherein the processing device is further configured to:
responsive to determining that the confidence score fails to meet the confidence threshold, create a partial customer profile for a person identified by the identification document, wherein the partial customer profile comprises the personal identifying information item.

17. A non-transitory computer-readable storage medium comprising executable instructions which, when executed by a computer system, cause the computer system to:
receive an identification document image produced by a mobile communication device;
extract, from the identification document image, a personal identifying information item;
compute a confidence score of the personal identifying information item;
responsive to determining that the confidence score meets or exceeds a confidence threshold, create a customer profile for a person identified by an identification document represented by the identification document image, wherein the customer profile comprises the personal identifying information item; and
create, using the customer profile, a financial account for the person identified by the identification document.

18. The non-transitory computer-readable storage medium of claim 17, wherein computing the confidence score of the personal identifying information item further comprises:
adjusting the confidence score by a value indicative of outcome of validation of the personal identifying information item against an external information source.

19. The non-transitory computer-readable storage medium of claim 17, wherein computing the confidence score of the personal identifying information item further comprises:
computing a first scoring factor by comparing a geolocation tag associated with the identification document image and a geolocation of a venue of a specified event;
computing a second scoring factor by comparing a timestamp of the identification document image and a schedule of the specified event; and
adjusting the confidence score by a value indicative of a combination of the first scoring factor and the second scoring factor.

20. The non-transitory computer-readable storage medium of claim 17, further comprising executable instructions causing the computer system to:
adjust the confidence threshold based on validating account creation data of a plurality of financial accounts.
